(19) United States
(12) Patent Application Publication
(10) Pub. No.: US 2025/0338803 A1
(43) Pub. Date: Nov. 6, 2025

(54) PLANT FEEDING SPIKE DEVICE FOR SUB-SURFACE IRRIGATION AND FERTILIZATION

(71) Applicant: Geoffrey Dodge, South Salem, NY (US)

(72) Inventor: Geoffrey Dodge, South Salem, NY (US)

(21) Appl. No.: 19/209,979

(22) Filed: May 16, 2025

Related U.S. Application Data
(60) Provisional application No. 63/533,769, filed on Aug. 21, 2023.

(51) Int. Cl. A01G 29/00; A01C 23/02

(52) U.S. Cl. CPC A01G 29/00; A01C 23/026

(57) ABSTRACT

The present disclosure relates to a plant feeding spike device (100) for sub-surface irrigation and fertilization. The device (100) comprising a hollow pipe (102). The hollow pipe (102) has a pointed end (104) configured to penetrate soil. The hollow pipe (102) has a threaded end (106) opposite to the pointed end (102). The device (100) also comprising a plurality of hole (108) positioned on along the circumference of the hollow pipe (102) and the holes (108) configured to deliver water or a water-based fertilizer mixture. The holes (108) are placed near the pointed end (104). The holes (108) are arranged to direct fluid flow away from the root ball and toward the walls of an excavated planting hole. The device (100) also comprising a threaded adapter (110) connected to the threaded end (106) of the hollow pipe (102) and the threaded adapter (110) configured to connect to a spray gun.

### FIELD OF THE INVENTION

Embodiments of the present invention relate to field of irrigation and nutrient transfer and specifically relates to a plant feeding device for sub-surface irrigation and fertilization.

### DESCRIPTION OF THE RELATED ART

Transplanting trees and shrubs, is a highly delicate and labor-intensive process that comes with significant challenges and costs. The process involves relocating a plant from one location to another, often with the root system being disturbed or partially removed. Whether moving plants within a nursery or directly into a new landscape, ensuring the survival and long-term health of the transplanted vegetation requires meticulous care.

One of the primary concerns during this process is the preservation and functionality of the plant's root system. When plants are uprooted, the roots are often severed, compressed, or damaged. The roots that remain must adapt to new environmental conditions, including differences in soil composition, moisture levels, and nutrient availability. This stage is critical for the plant's survival as the roots need to acclimate to the new surroundings, assimilate available resources, and establish themselves to support overall plant health and growth.

In nursery settings, root systems are often confined within containers or limited spaces, leading to compact and underdeveloped roots. Such conditions result in plants that are less resilient to the stresses of transplantation. Additionally, during planting or transplanting, the process of digging holes can leave the surrounding soil walls hard and compacted, creating a physical barrier for root growth and resource absorption. This further complicates the plant's ability to establish itself in its new environment.

Traditional methods and equipment for aiding tree and shrub transplantation often fall short in addressing these challenges. Conventional tree-feeding apparatuses, for instance, deliver water and fertilizer in all directions, indiscriminately saturating the surrounding soil and root ball. While this approach can help hydrate the plant, it may also inadvertently damage the sensitive root system by dislodging soil around the roots or creating unnecessary pressure on the root ball, leading to further root damage, delayed establishment, and, in some cases, transplant failure.

A key factor in ensuring the successful transplantation of trees and shrubs is the ability to prepare the planting site in a way that supports the plant's root system during its vulnerable acclimation period. For new plantings, breaking down the compacted walls of the planting hole is essential to encourage root penetration into the surrounding soil. This improves the plant's ability to access water, oxygen, and nutrients, all of which are critical for growth and recovery after transplantation.

Additionally, the delivery of water and nutrients must be precise and controlled to avoid causing further harm to the delicate root system. Instead of saturating the root ball itself, it is often more beneficial to direct resources to the surrounding soil, which promotes the expansion of roots into the planting hole, enhancing stability and nutrient uptake.

Therefore, the present invention provides a plant feeding device for sub-surface irrigation and fertilization.

### SUMMARY OF THE INVENTION

Embodiments of the present invention relate to a plant feeding spike device for sub-surface irrigation and fertilization. The device comprising a hollow pipe. The hollow pipe has a pointed end configured to penetrate soil. The hollow pipe has a threaded end opposite to the pointed end. The device also comprising a plurality of hole positioned on along the circumference of the hollow pipe and the holes configured to deliver water or a water-based fertilizer mixture. The holes are placed near the pointed end. The holes are arranged to direct fluid flow away from the root ball and toward the walls of an excavated planting hole. The device also comprising a threaded adapter connected to the threaded end of the hollow pipe and the threaded adapter configured to connect to a spray gun.

In accordance with an embodiment of the present invention, the hollow pipe is made of rigid material.

In accordance with an embodiment of the present invention, the hollow pipe is resistant to corrosion.

In accordance with an embodiment of the present invention, the hollow pipe includes an internal coating to prevent clogging by mineral deposits.

In accordance with an embodiment of the present invention, the length of the hollow pipe varies from 10 inches to 24 inches.

In accordance with an embodiment of the present invention, the holes occupy half of the hollow pipe's circumference.

In accordance with an embodiment of the present invention, the pointed end of the hollow pipe is conical in shape to facilitate soil penetration.

In accordance with an embodiment of the present invention, the device further comprising a valve assembly integrated near the threaded end of the hollow pipe to regulate flow rate.

In accordance with an embodiment of the present invention, the hollow pipe includes measurement markings to indicate the depth of penetration.

Another embodiment of the present invention relates to a method for delivering water or a water-fertilizer mixture to plant roots below the soil surface. The method comprising using a hollow pipe made of metal or rigid material. The hollow pipe comprises a pointed end for penetrating the soil, a threaded end opposite the pointed end, and a plurality of holes positioned along the circumference of the hollow pipe. The method also comprising attaching the threaded end of the hollow pipe to a conventional tree spraying gun or a spray gun using a threaded adaptor. The method also comprising positioning the pointed end of the hollow pipe at the desired location near the plant roots. The method also comprising activating the spray gun to deliver water or a water-fertilizer mixture through the hollow pipe. The method also comprising allowing the water or fertilizer to flow through the holes near the pointed end, ensuring targeted delivery to the plant roots. The method also comprising removing the pipe from the soil after the desired amount of water or fertilizer has been delivered.

In accordance with an embodiment of the present invention, the method also includes inserting the pointed end of the pipe into the soil to the desired depth, ensuring that the holes are positioned to direct fluid away from the root ball toward the wall of the planting hole.

In accordance with an embodiment of the present invention, the insertion is performed at a pre-determined angle to further direct fluid flow towards the roots.

In accordance with an embodiment of the present invention, the depth of the insertion is adjusted as per the requirement.

In accordance with an embodiment of the present invention, the holes are angled to direct fluid flow outward from the hollow pipe.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1A illustrates a block diagram for a plant feeding spike device 100 for sub-surface irrigation and fertilization, in accordance with an embodiment of the present invention;

FIG. 1B illustrates a prototype of a plant feeding spike device, in accordance with an embodiment of the present invention;

FIG. 1C illustrates a prototype of a pointed end for a plant feeding spike device, in accordance with an embodiment of the present invention;

FIG. 1D illustrates a prototype of a threaded adaptor for a plant feeding spike device, in accordance with an embodiment of the present invention;

FIG. 1E illustrates a comparative view of a standard adaptor and a threaded adaptor for a plant feeding spike device, in accordance with an embodiment of the present invention;

FIG. 1F illustrates a perspective view of a plant feeding spike device, in accordance with an embodiment of the present invention;

FIG. 1G illustrates another perspective view of a plant feeding spike device, in accordance with an embodiment of the present invention; and

FIG. 2 illustrates a flowchart diagram for a method for delivering water or a water-fertilizer mixture to plant roots below the soil surface, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

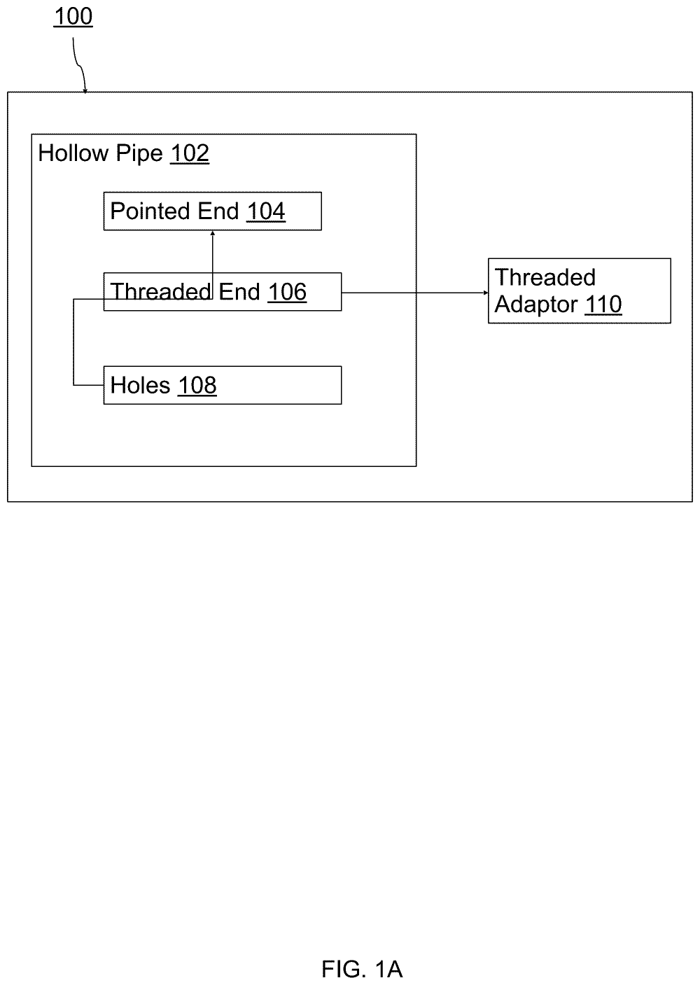

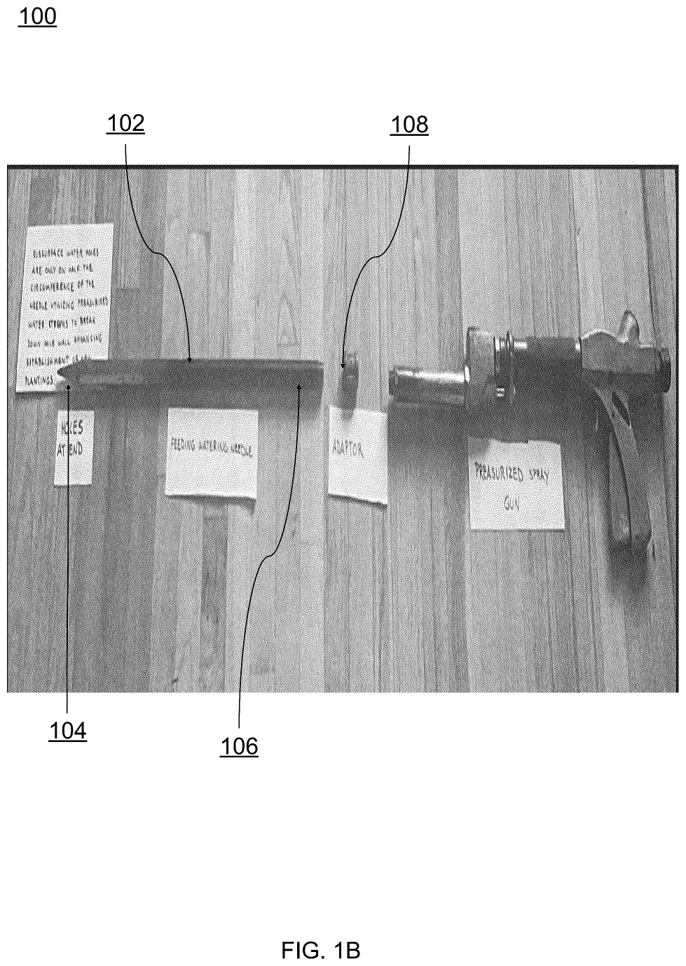

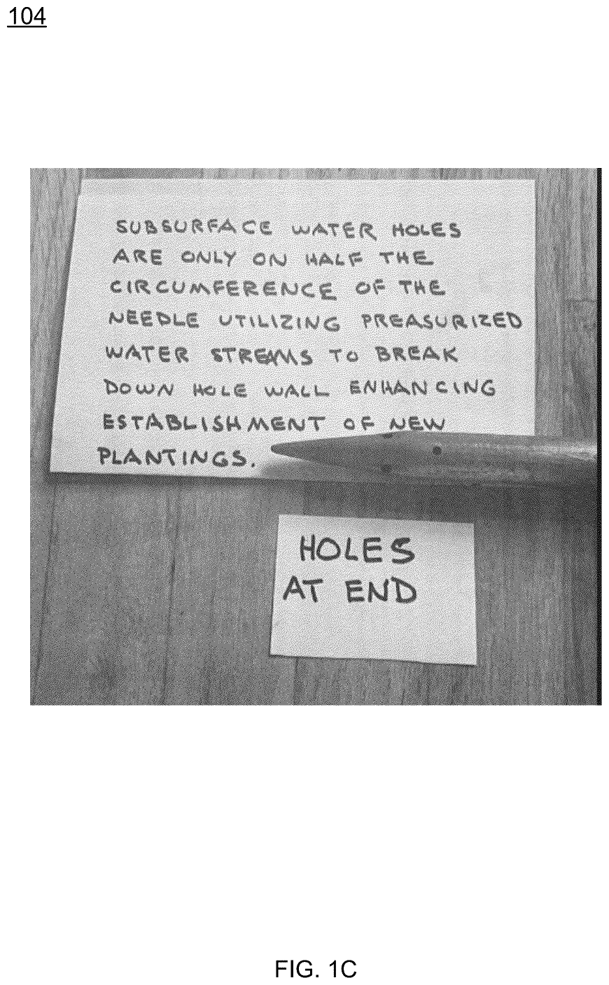

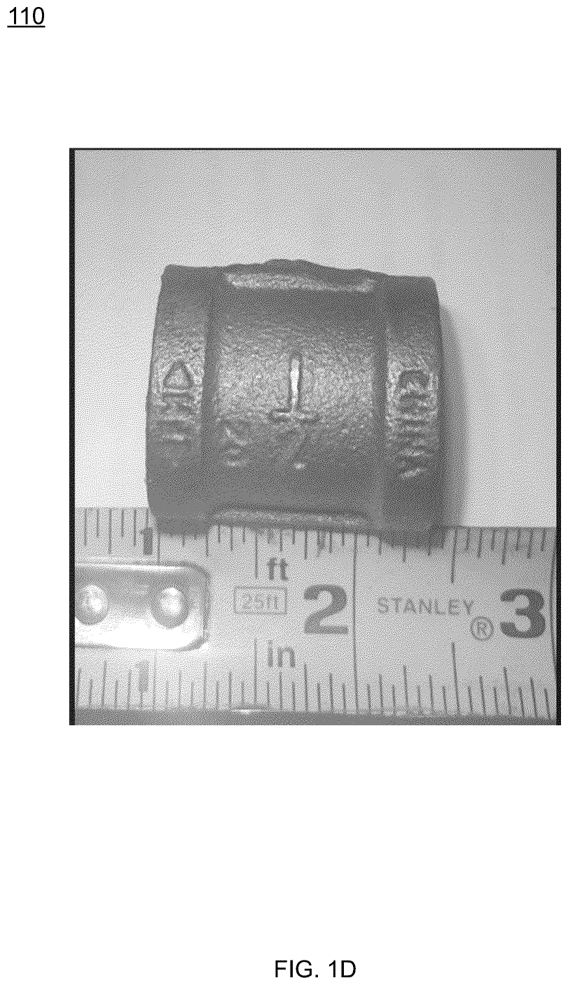

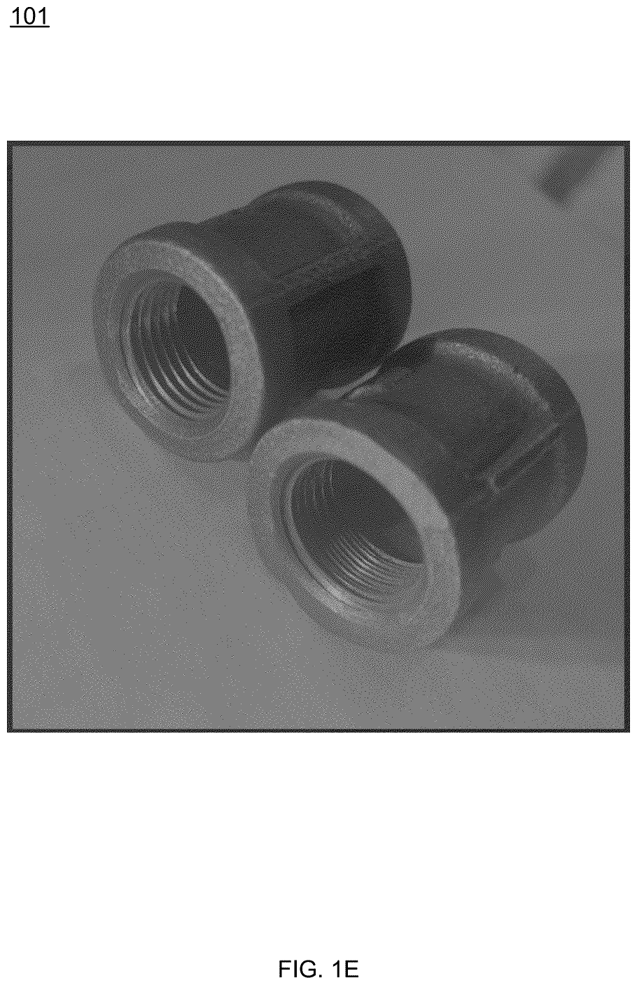

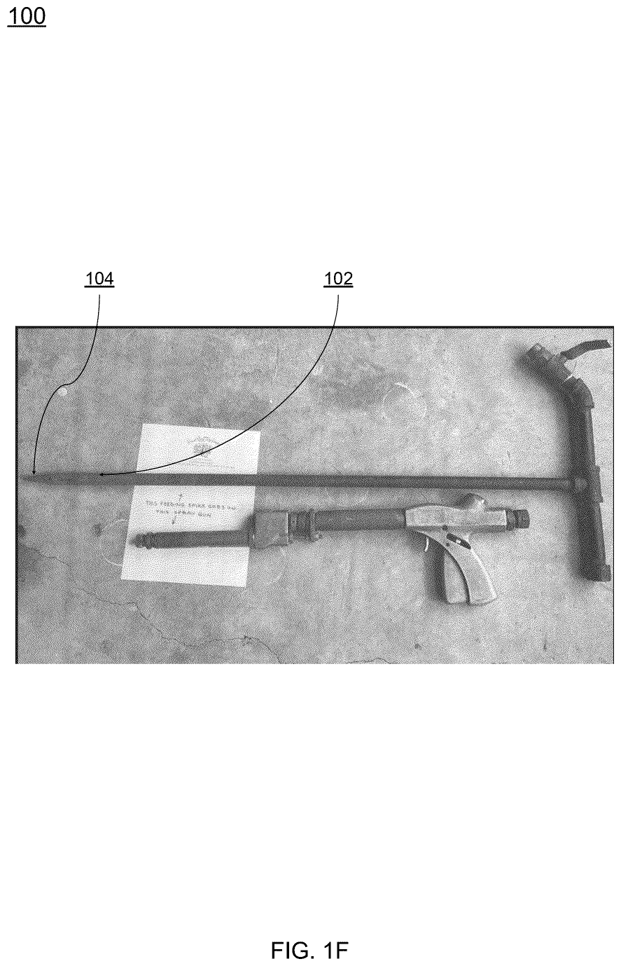

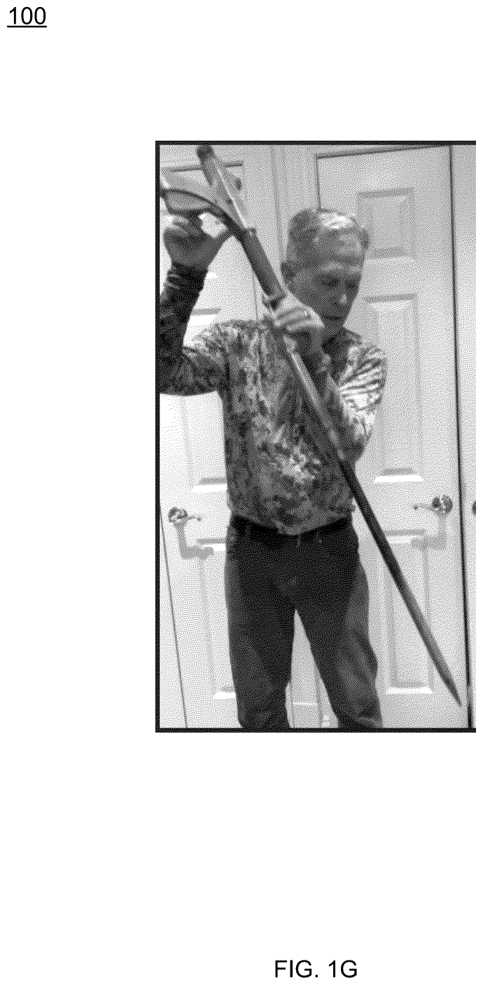

FIG. 1A illustrates a block diagram for a plant feeding spike device 100 for sub-surface irrigation and fertilization, in accordance with an embodiment of the present invention.

FIG. 1B illustrates a prototype of a plant feeding spike device 100, in accordance with an embodiment of the present invention.

FIG. 1C illustrates a prototype of a pointed end 104 for a plant feeding spike device 100, in accordance with an embodiment of the present invention.

The device 100 may be comprising a hollow pipe 102, a plurality of hole 108, and a threaded adapter 110.

In an embodiment of the present disclosure, the hollow pipe 102 may be made up of metal and/or a rigid polymer material resistant to corrosion. The thickness of the hollow pipe 102 may vary as per the application. The diameter of the hollow pipe 102 may vary as per the application. Embodiments of the present disclosure are intended to cover or otherwise include all kinds of metals, metallic alloys, and/or metal coated with corrosion-resistant coating material, and such.

The hollow pipe 102 may have a pointed end 104 configured to penetrate soil. The hollow pipe 102 may have a threaded end 106 opposite to the pointed end 104.

The plurality of hole 108 may be positioned on along the circumference of the hollow pipe 102 and the holes 108 configured to deliver water or a water-based fertilizer mixture. The holes 108 may be placed near the pointed end 104. The holes 108 may be arranged to direct fluid flow away from the root ball and toward the walls of an excavated planting hole.

The hollow pipe 102 may be made of rigid material.

The hollow pipe 102 may be resistant to corrosion.

The hollow pipe 102 may include an internal coating to prevent clogging by mineral deposits.

The length of the hollow pipe 102 may vary from 10 inches to 24 inches.

The holes 108 may occupy half of the hollow pipe's 102 circumference.

The pointed end 104 of the hollow pipe 102 may be conical in shape to facilitate soil penetration.

In an embodiment of the present disclosure, the pointed end 104 includes reinforced material for durability in rocky or hard soils. In an embodiment of the present disclosure, the size and spacing of the holes 108 are optimized to ensure even distribution of water or fertilizer.

In an embodiment of the present disclosure, the conical angle of the pointed end 104 may vary. In an embodiment of the present disclosure, the diameter of the holes 108 may vary. In an embodiment of the present disclosure, the diameter of the holes 108 on the circumference of the hollow pipe 102 may vary.

FIG. 1D illustrates a prototype of a threaded adaptor 104 for a plant feeding spike device 100, in accordance with an embodiment of the present invention.

FIG. 1E illustrates comparative view of a standard adaptor and the threaded adaptor 104 for a plant feeding spike device 100, in accordance with an embodiment of the present invention.

In the FIG. 1E, the left one is the standard adaptor with standard coarse thread and the one on the right shows the threaded adaptor 104 with the customized threads for the spray gun.

The threaded adapter 110 may be connected to the threaded end 106 of the hollow pipe 102 and the threaded adapter 110 configured to connect to a spray gun.

In an embodiment of the present disclosure, the threaded adapter 110 may facilitate secure attachment of the threaded end 106 of the hollow pipe 102 to a high-pressure tree spraying gun. In some embodiments, the hollow pipe 102 may include a removable cap at the threaded end 106 for cleaning or maintenance. In an embodiment of the present disclosure, the threaded end 106 may be compatible with standard garden and irrigation spray guns.

FIG. 1F illustrates a perspective view of a plant feeding spike device 100, in accordance with an embodiment of the present invention.

FIG. 1G illustrates another perspective view of a plant feeding spike device 100, in accordance with an embodiment of the present invention.

The device 100 may further be comprising a valve assembly integrated near the threaded end 106 of the hollow pipe 102 to regulate flow rate.

The hollow pipe 102 may include measurement markings to indicate the depth of penetration.

In some embodiment, the device 100 may include a detachable handle for manual use without a spray gun. In an embodiment of the present disclosure, the hollow pipe 102 may be designed to withstand pressures up to 100 psi. In some embodiments, the pointed end 104 may include a textured surface to reduce slippage during soil penetration. In some embodiments, the hollow pipe 102 may be designed for modular connection to extend the length as needed.

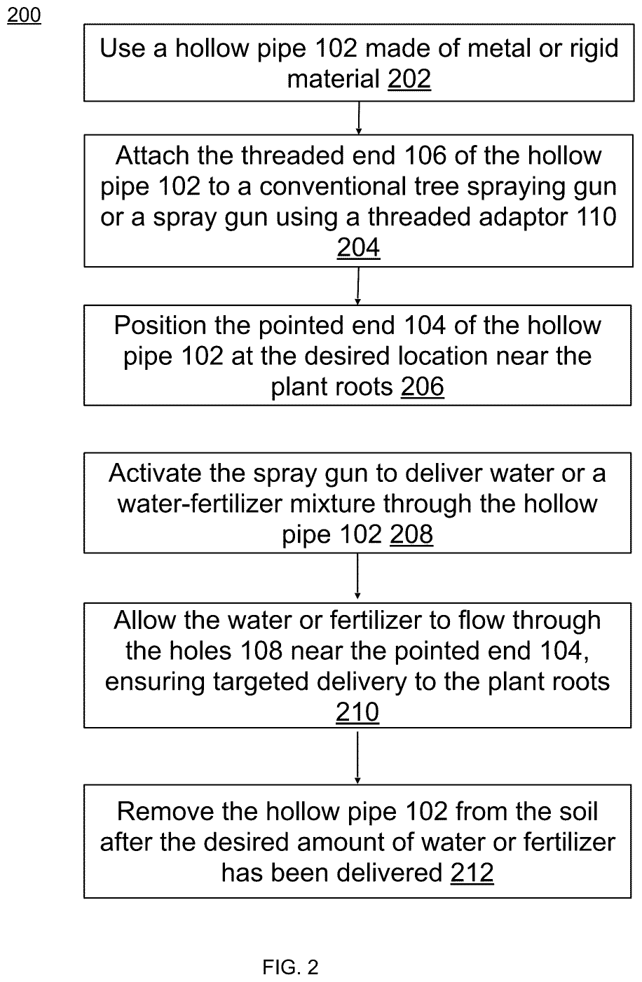

FIG. 2 illustrates a flowchart diagram for a method 200 for delivering water or a water-fertilizer mixture to plant roots below the soil surface, in accordance with an embodiment of the present invention.

The method 200 may be comprising the following steps.
At 202, using a hollow pipe 102 made of metal or rigid material. The hollow pipe 102 may comprise a pointed end for penetrating the soil, a threaded end 106 opposite a pointed end 104, and a plurality of holes 108, positioned along the circumference of the hollow pipe 102.
At 204, attaching the threaded end 106 of the hollow pipe 102 to a conventional tree spraying gun or a spray gun using a threaded adaptor 110.
At 206, positioning the pointed end 104 of the hollow pipe 102 at the desired location near the plant roots.
At 208, activating the spray gun to deliver water or a water-fertilizer mixture through the hollow pipe 102.
At 210, allowing the water or fertilizer to flow through the holes 108 near the pointed end 104, ensuring targeted delivery to the plant roots.
At 212, removing the hollow pipe 102 from the soil after the desired amount of water or fertilizer has been delivered.

The method 200 may also include inserting the pointed end 104 of the hollow pipe 102 into the soil to the desired depth, ensuring that the holes 108 are positioned to direct fluid to the desired area.

The insertion of the hollow pipe 102 may be performed at a pre-determined angle to further direct fluid flow towards the roots.

The depth of the insertion of the hollow pipe 102 may be adjusted as per the requirement.

The holes 108 may be angled to direct fluid flow outward from the hollow pipe 102.

In an embodiment of the present disclosure, for feeding newly planted trees or shrubs to ensure establishment and health with liquid feeding from a spray gun by an easy convenient lightweight compact versatile and inexpensive device 100. The device 100 may simply screw on like a garden house by means the threaded adaptor 110 on the spray gun. The threading on the threaded adaptor 110 may be compatible with the threaded end 106 and the conventional spray gun.

In an embodiment of the present disclosure, the method 200 may direct pressurized water at the hole wall of new planting breaking down the hole wall for faster assimilation, acclamation and establishment. The pointed end 104 of the device 100 having the holes 108 may be inserted into the ground between the root ball and root ball hole wall so is directed to break down the hole wall initiating assimilation, acclamation and establishment of new plant material.

In an embodiment of the present disclosure, the threaded adaptor 110 may be compatible with conventional high pressure tree spraying guns, a plant feeder as well as a tree sprayer. In an embodiment of the present disclosure, the shape and size of the threaded adaptor 110 may vary. In an embodiment of the present disclosure, the device 100 may include more than one threaded adaptor 110. Embodiments of the present disclosure are intended to cover or otherwise include all kinds of metals, metallic alloys, and/or metal coated with corrosion-resistant coating material, and such for the threaded adaptor 110.

In an embodiment of the present disclosure, the sub-surface holes 108 combined with the pressurized water stream may aid in breaking down the hole wall and enhancing the establishment of the new plantings. In an embodiment of the present disclosure, the holes 108 may or may not be uniform in size and shape.

The disclosed offers several advantages that make it a highly valuable tool for landscaping, horticulture, and tree transplantation efforts. By directing water and nutrients specifically to the specific area, the disclosed invention minimizes root damage and improves root establishment in the new soil. The disclosed invention encourages root acclimation and assimilation, which significantly reduces the risk of transplant failure, ensuring healthier growth after planting.

The pressurized streams of water or nutrient solution through the disclosed invention, loosen the compacted walls of the planting hole, allowing plant roots to grow outward easily. Thus, stimulating outward root growth fosters a stronger and more extensive root system, improving plant stability and access to nutrients. Unlike conventional feeding systems, which saturate the entire area and may disturb the sensitive root ball, the disclosed invention keeps the root ball intact by directing pressurized water or fertilizer to a desired area. As a result, preserving the root ball ensures that the plant's essential roots remain undisturbed during the acclimation period.

The disclosed invention delivers water directly to where it is needed, minimizing water runoff and wastage. The disclosed invention also directs fertilizers and nutrient to the areas where root growth is desired, preventing overuse and ensuring maximum efficiency. The disclosed invention simplifies soil preparation and feeding, reducing the time and effort required for planting or transplanting. As the plants that establish quickly and efficiently require less ongoing care, resulting in long-term cost savings.

The disclosed invention is versatile that can be used in different soil conditions, including clay, loam, and sandy soils. The disclosed invention can be customized in size and length to accommodate different plant species and transplantation needs. By using water and fertilizer efficiently and reducing waste, the disclosed invention supports sustainable landscaping practices. Furthermore, precision nutrient delivery helps prevent excess fertilizers from leaching into groundwater or surrounding ecosystems.

Existing liquid tree feeding spikes are large and cumbersome and not designed specifically for newly planted plant material whereas this device 100 may offer easy penetration in the soil. The existing plant feeders are larger, bulkier and require more time for set up whereas the device 100 is lighter and simple one-piece screw on attachment to the spray gun.

In addition, length, diameter, and placement of the holes 108 on the device 100 can be customized to suit specific plant species or soil conditions. The threaded end 106 allows the device 100 to be attached to conventional high-pressure spray guns, making it easy to integrate into existing horticultural practices. The simple design makes the device 100 accessible to both professionals and amateurs in gardening and landscaping, with minimal or no training requirements.

The disclosed invention is useful for professional landscapers and nursery operators working with ornamental plants, trees, and shrubs. The disclosed invention is useful for large-scale tree planting projects aimed at reforestation or afforestation. The disclosed invention facilitates tree planting in urban environments where soil conditions may be particularly compacted or challenging. By encouraging quick root expansion into surrounding soil, the disclosed invention helps secure the plant, reducing soil erosion around the planting site.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A plant feeding spike device for sub-surface irrigation and fertilization, the device comprising:
a hollow pipe,
wherein the hollow pipe has a pointed end configured to penetrate soil,
wherein the hollow pipe has a threaded end opposite to the pointed end;
a plurality of hole positioned on along the circumference of the hollow pipe, the holes configured to deliver water or a water-based fertilizer mixture,
wherein the holes are placed near the pointed end,
wherein the holes are arranged to direct fluid flow away from the root ball and toward the walls of an excavated planting hole; and
a threaded adapter connected to the threaded end of the hollow pipe, the threaded adapter configured to connect to a spray gun.

2. The device of claim 1, wherein the hollow pipe is made of rigid material.

3. The device of claim 2, wherein the hollow pipe is resistant to corrosion.

4. The device of claim 2, wherein the hollow pipe includes an internal coating to prevent clogging by mineral deposits.

5. The device of claim 1, wherein the length of the hollow pipe varies from 10 inches to 24 inches.

6. The device of claim 1, wherein the holes occupy half of the hollow pipe's circumference.

7. The device of claim 1, wherein the pointed end of the hollow pipe is conical in shape to facilitate soil penetration.

8. The device of claim 1, the device further comprising a valve assembly integrated near the threaded end of the hollow pipe to regulate flow rate.

9. The device of claim 1, the hollow pipe includes measurement markings to indicate the depth of penetration.

10. A method for delivering water or a water-fertilizer mixture to plant roots below the soil surface, the method comprising:
using a hollow pipe made of metal or rigid material,
wherein the hollow pipe comprises a pointed end for penetrating the soil, a threaded end opposite the pointed end, and a plurality of holes positioned along the circumference of the hollow pipe;
attaching the threaded end of the hollow pipe to a conventional tree spraying gun or a spray gun using a threaded adaptor;
positioning the pointed end of the hollow pipe at the desired location near the plant roots;
activating the spray gun to deliver water or a water-fertilizer mixture through the hollow pipe;
allowing the water or fertilizer to flow through the holes near the pointed end, ensuring targeted delivery to the plant roots; and
removing the hollow pipe from the soil after the desired amount of water or fertilizer has been delivered.

11. The method as claimed in claim 10, wherein the method also includes inserting the pointed end of the pipe into the soil to the desired depth, ensuring that the holes are positioned to direct fluid towards the desired area.

12. The method as claimed in claim 11, wherein the insertion is performed at a pre-determined angle to further direct fluid flow towards the roots.

13. The method as claimed in claim 11, wherein the depth of the insertion is adjusted as per the requirement.

14. The method as claimed in claim 11, wherein the holes are angled to direct fluid flow outward from the hollow pipe.
